(19) United States
(12) Patent Application Publication
(10) Pub. No.: US 2008/0242788 A1
(43) Pub. Date: Oct. 2, 2008

(54) Polypropylene composition

(76) Inventor: Kenji Kimura, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 12/073,633

(22) Filed: Mar. 7, 2008

(30) Foreign Application Priority Data
Mar. 7, 2007 (JP) 2007-056888

(51) Int. Cl. C08K 3/34

(52) U.S. Cl. 524/451

(57) ABSTRACT

An object of the present invention is to provide a polypropylene composition which is excellent in any performance of mechanical property, stability to thermal oxidation, and coloration resistance of the resulting molded article.

There is provided a polypropylene composition comprising 0.001 to 0.5 part by weight of at least one kind neutralizing agent selected from the group consisting of hydrotalcites, metal hydroxide and a carboxylic acid metal salt, 0.01 to 0.5 part by weight of a phenol-based antioxidant represented by the formula (1), 0.01 to 0.5 part by weight of a sulfur-based antioxidant represented by the formula (2), 0.01 to 0.5 part by weight of at least one kind phosphorus-based antioxidant selected from the group consisting of a compound represented by the formula (3) and a compound represented by the formula (4), 0.01 to 0.8 part by weight of a metal silicate salt, and 100 parts by weight of polypropylene, provided that, when a bisphenol A type glycidyl ether-based epoxide compound represented by the formula (5) and/or carboxylic acid amide having a carbon number of 8 to 50 are (is) contained in the composition, a content of the bisphenol A type glycidyl ether-based epoxide compound represented by the formula (5) is 0.001 part by weight or less, and a content of the carboxylic acid amide having a carbon number of 8 to 50 is 0.001 part by weight or less.

### FIELD OF THE INVENTION

The present invention relates to a polypropylene composition.

### BACKGROUND ART

Since polypropylene has the excellent physical, chemical and electrical properties, it has been recently used in a variety of fields such as case bodies for electronic parts, electric parts and automobile parts.

In order to improve stability of polypropylene to thermal oxidation and improve such coloration resistance that polypropylene is not colored even when it is exposed under the nitrogen oxide (NO_{X}) atmosphere, a polypropylene composition in which an inorganic filler, a phenol-based antioxidant, a sulfur-based antioxidant, an amide-based compound and a bisphenol A type glycidyl ether-based epoxy compound are added to polypropylene is proposed in Patent Publication 1.

### [Patent Publication 1]

JP 05-271481A (claim 1, Problems to be solved by the invention)

### DISCLOSURE OF THE INVENTION

Recently, a polypropylene composition with improved stability to thermal oxidation and improved coloration resistance has been demanded.

An object of the present invention is to provide a polypropylene composition which is excellent in mechanical property, and is further excellent in both properties of stability to thermal oxidation, and coloration resistance.

The present inventors studied and, as a result, found out that a polypropylene composition in which a metal silicate salt is used as an inorganic filler, a specified phosphorus-based antioxidant is used as an antioxidant, and a bisphenol A type glycidyl ether-based epoxy compound and a carboxylic acid amide-based compound are adjusted to specified amounts or smaller can solve such the problems.

That is, the present invention provides the following [1] to [6].

[1] A polypropylene composition comprising 0.001 to 0.05 part by weight of at least one kind neutralizing agent selected from the group consisting of hydrotalcites, metal hydroxide and a carboxylic acid metal salt, 0.01 to 0.5 part by weight of a phenol-based antioxidant represented by the formula (1), 0.01 to 0.5 part by weight of a sulfur-based antioxidant represented by the formula (2), 0.01 to 0.5 part by weight of at least one kind phosphorus-based antioxidant selected from the group consisting of a compound represented by the formula (3) and a compound represented by the formula (4), 0.01 to 0.8 part by weight of a metal silicate salt, and 100 parts by weight of polypropylene, provided that, when a bisphenol A type glycidyl ether-based epoxide compound represented by the formula (5) and/or carboxylic acid amide having a carbon number of 8 to 50 are (is) contained in the composition, a content of the bisphenol A type glycidyl ether-based epoxide compound represented by the formula (5) is 0.001 part by weight or less, and a content of the carboxylic acid amide having a carbon number of 8 to 50 is 0.001 part by weight or less.

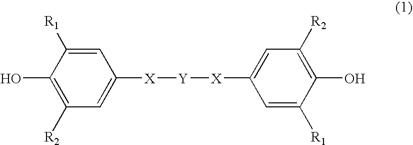

[In the formula (1), R₁s each represent independently a linear alkyl group having a carbon number of 1 to 8, or a branched alkyl group having a carbon number of 3 to 8, R₂s represent a methyl group, X represents a —C₂H₄COO— group, and Y represents a divalent alcohol residue having a carbon number of 1 to 18, wherein a methylene group contained in the alcohol residue may be substituted with a cycloalkylene group or a hatero atom, and a methylene group contained in the cycloalkylene group may be substituted with a hetero atom]

(R₃-A-S—C₂H₄CO₂)ₘ-Z (2)

[In the formula (2), R₃ represents an alkyl group having a carbon number of 12 to 18, A represents a single bond or a —C₂H₄CO₂— group, m represents an integer of 1 to 4, and Z represents a m-valent alcohol residue having a carbon number of 5 to 18]

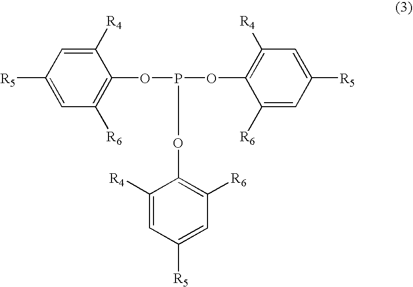

[In the formula (3), R₄s, R₅s and R₆s each represent independently a hydrogen atom, a linear alkyl group having a carbon number of 1 to 9, or a branched alkyl group having a carbon number of 3 to 9]

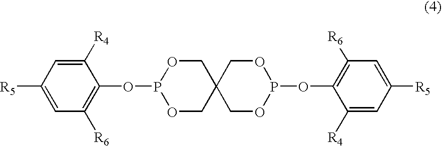

[In the formula (4), R₄s, R₅s and R₆s are as defined above]

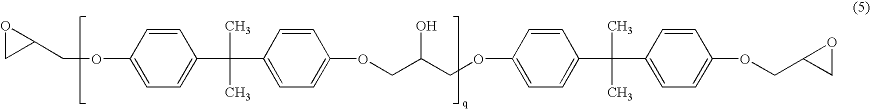

[In the formula (5), q represents a number of 0 or more]

[2] The composition according to [1], wherein the composition does not substantially contain the bisphenol A type glycidyl ether-based epoxide compound represented by the formula (5) and the carboxylic acid amide having a carbon number of 8 to 50.

[3] The composition according to [1], wherein the neutralizing agent is a carboxylic acid metal salt having a carbon number of 8 to 22.

[4] The composition according to [1] or [3], wherein the neutralizing agent is hydrotalcites.

[5] A method of stabilizing a polypropylene composition, comprising melt-kneading a composition comprising 0.001 to 0.5 part by weight of at least one kind neutralizing agent selected from the group consisting of hydrotalcites, metal hydroxide and a carboxylic acid metal salt, 0.01 to 0.5 part by weight of a phenol-based antioxidant represented by the formula (1), 0.01 to 0.5 part by weight of a sulfur-based antioxidant represented by the formula (2), 0.01 to 0.5 part by weight of at least one kind phosphorus-based antioxidant selected from the group consisting of a compound represented by the formula (3) and a compound represented by the formula (4), 0.01 to 0.8 part by weight of a metal silicate salt, and 100 parts by weight of polypropylene, provided that, when a bisphenol A type glycidyl ether-based epoxy compound represented by the formula (5) and/or carboxylic acid amide having a carbon number of 8 to 50 are (is) contained in the composition, a content of the bisphenol A type glycidyl ether-based epoxy compound represented by the formula (5) is 0.001 part by weight or less, and a content of the carboxylic acid amide having a carbon number of 8 to 50 is 0.001 part by weight or less.

[6] The composition according to [5], wherein the composition does not substantially contain the bisphenol A type glycidyl ether-based epoxy compound represented by the formula (5) and the carboxylic acid amide having a carbon number of 8 to 50.

### MODE FOR CARRYING OUT THE INVENTION

The present invention will be explained in detail below.

The propylene composition of the present invention contains the neutralizing agent at 0.001 to 0.5 part by weight, preferably 0.01 to 0.3 part by weight, particularly preferably 0.02 to 0.2 part by weight based on 100 parts by weight of polypropylene. When the neutralizing agent is 0.001 part by weight or more, there is a tendency that corrosion of an instrument used upon processing of the polypropylene composition is reduced for a long period of time, and there is a tendency that, when the present composition is molded, appearance deterioration such as occurrence of roughening of a surface, eye discharge and the like is reduced, being preferable. When the neutralizing agent is 0.5 part by weight or less, there is a tendency that a modulus and a loading deflection temperature of a molded article of the polypropylene are improved to improve mechanical property, that an embrittlement life of a gear oven (hereinafter, referred to as GO embrittlement life in some cases) is prolonged, and stability to thermal oxidation is improved, and that NOₓ coloring property is improved, being preferable.

Herein, the neutralizing agent refers to at least one kind selected from the group consisting of hydrotalcites such as synthetic hydrotalcite, and natural hydrotalcite; metal hydroxide such as calcium hydroxide; carboxylic acid metal salt such as calcium stearate, calcium palmitate, aluminum stearate, zinc stearate, calcium myristate, calcium laurate, and magnesium stearate.

Among them, a carboxylic acid metal salt having a carbon number of 8 to 22, and hydrotalcites are preferable, and hydrotalcite, calcium stearate, and calcium palmitate are particularly preferable.

The polypropylene composition of the present invention contains the phenol-based antioxidant represented by the formula (1) at 0.01 to 0.5 part by weight, preferably 0.01 to 0.2 part by weight, particularly preferably 0.02 to 0.1 part by weight based on 100 parts by weight of polypropylene.

When the phenol-based antioxidant (1) is 0.01 part by weight or more, the oxidation preventing performance is excellent, being preferable. When the phenol-based antioxidant is 0.5 part by weight or less, there is a tendency that, when the resulting polypropylene composition is molded, bleeding from the molded article is suppressed, being preferable.

In the formula (1), R₁s and R₂s each represent independently a linear or branched alkyl group having a carbon number of 1 to 8. Examples of the alkyl group include a methyl group, an ethyl group, an isopropyl group, a t-butyl group, a t-pentyl group, and a t-octyl group. As R₁, inter alia, a branched alkyl group having a carbon number of 3 to 8 is preferable, and a t-butyl group, a t-pentyl group and a t-octyl group are particularly preferable.

R₂ is a methyl group.

X represents a —C₂H₄COO— group. Usually, an ester group side of X is bound to Y.

Y represents the divalent alcohol residue having a carbon number of 1 to 18. A methylene group of the alcohol residue may be substituted with a cycloalkylene group or a hetero atom, and a methylene group of the cycloalkylene group may be substituted with a hetero atom. Examples of the hetero atom include an oxygen atom, a nitrogen atom and a sulfur atom.

As an embodiment of Y, a triethylene glycol residue, and a 3,9-bis(1,1-dimethyl-2-hydroxyethyl)-2,4,8,10-tetraoxaspiro [5.5]undecane residue are preferable.

Embodiments of the phenol-based antioxidant (1) include 3,9-bis[2-{3-(3-t-butyl-4-hydroxy-5-methylphenyl)propionylo xy}-1,1-dimethylethyl]-2,4,8,10-tetraoxaspiro[5.5]undecane (hereinafter, referred to as (1-1) in some cases).

The polypropylene composition of the present invention contains the sulfur-based antioxidant represented by the formula (2) at 0.01 to 0.5 part by weight, preferably 0.01 to 0.03 part by weight, particularly preferably 0.02 to 0.2 part by weight based on 100 parts by weight of polypropylene. When the sulfur-based antioxidant (2) than 0.01 part by weight or more, there is a tendency that when the resulting polypropylene composition is molded, the oxidation preventing performance of the molded article is improved, being preferable. When the sulfur-based antioxidant (2) is 0.5 part by weight or less, there is a tendency that an odor of the resulting polypropylene composition is suppressed, being preferable.

In the formula (2), R₃ represents an alkyl group having a carbon number of 12 to 18 such as a dodecyl group, a tetradecyl group, and an octadecyl group. A represents a single bond or a —C₂H₄CO₂— group and m represents an integer of 1 to 4.

Z represents a m-valent alcohol residue having a carbon number of 5 to 18 such as a dodecyl alcohol residue, a tetradecyl alcohol residue, an octadecyl alcohol residue, and a pentaerythritol residue, and m represents an integer of 1 to 4.

Embodiments of the sulfur-based antioxidant (2) include
3,3′-thiodipropionic acid di-n-dodecyl ester,
3,3′-thiodipropionic acid di-n-tetradecyl ester,
3,3′-thiodipropionic acid di-n-octadecyl ester (hereinafter, referred to as (2-1) in some cases), and tetrakis(3-n-dodecylthiopropionic acid) pentaerythrityl ester (hereinafter, referred to as (2-2) in some cases).

The polypropylene composition of the present invention contains the phosphorus-based antioxidants represented by the formula (3) and the formula (4) at a total of 0.01 to 0.5 part by weight, preferably 0.01 to 0.3 part by weight, particularly preferably 0.02 to 0.2 part by weight based on 100 parts by weight of polypropylene. As the phosphorus-based antioxidant, only any one of the phosphorus-based antioxidant represented by the formula (3) and the phosphorus-based antioxidant represented by the formula (4) may be used.

When a total amount of the phosphorus-based antioxidants (3) and (4) is 0.01 part by weight or more, there is a tendency that when the resulting polypropylene composition is molded, the oxidation preventing performance of the molded article is improved, being preferable. When a total amount of the phosphorus-based antioxidants (3) and (4) is 0.5 part by weight or less, there is a tendency that a black speck upon processing of a molded article when the resulting polypropylene composition is molded is suppressed, being preferable.

In the formulas (3) and (4), R₄s, R₅s and R₆s each represent independently a hydrogen atom, or a linear or branched alkyl group having a carbon number of 1 to 9. Inter alia, examples include a hydrogen atom, a methyl group, a t-butyl group, a t-pentyl group, a t-octyl group, and a nonyl group. Among them, a hydrogen atom, a methyl group and a t-butyl group are preferable.

Examples of the phosphorus-based antioxidant (3) include tris(nonylphenyl) phosphite, and tris(2,4-di-t-butylphenyl) phosphite (hereinafter, referred to as (3-1) in some cases).

Examples of the phosphorus-based antioxidant (4) include bis(2,4-di-t-butylphenyl) pentaerythritol diphosphite (hereinafter, referred to as (4-1) in some cases), and bis(2,6-di-t-butyl-4-methylphenyl) pentaerythritol diphosphite.

The polypropylene composition of the present invention is such that a content of the bisphenol A type glycidyl ether-based epoxy compound represented by the formula (5) is 0.001 part by weight or less based on 100 parts by weight of polypropylene. By adopting a content of the epoxy compound being 0.001 part by weight or less, there is a tendency that when the present composition is molded, a hue of the molded article is improved, being preferable.

Herein, q in the epoxy compound (5) is 0 or more, preferably 10 to 50. The epoxy compound is a product obtained by reacting bisphenol A and epichlorohydrin with a dehydrochlorinating agent such as sodium hydroxide, and the epoxy compound usually having q=about 35 is commercially available.

It is preferable that the polypropylene composition of the present invention does not substantially contain the epoxy compound.

The polypropylene composition of the present invention is usually such that a content of a carboxylic acid amide compound having a carbon number of 8 to 50 is 0.001 part by weight or less based on 100 parts by weight of polypropylene. It is preferable that the polypropylene composition of the present invention does not substantially contain the carboxylic acid amide compound. By adopting a content of the carboxylic acid amide being 0.001 part by weight or less, there is a tendency that, when the present composition is molded, a hue of the molded article is improved, being preferable.

Embodiments of the carboxylic acid amide-based compound in the present invention include saturated monocarboxylic acid amide such as erucic acid amide, and stearic acid amide, unsaturated monocarboxylic acid amide such as oleic acid amide, and behenic acid amide, saturated dicarboxylic acid amide such as N-stearylbutyric acid amide, N-stearyllauric acid amide, and N-stearylbehenic acid amide, and unsaturated dicarboxylic acid amide such as N-oleyloleic acid amide, N-oleylbehenic acid amide, N-butylerucic acid amide, N-octylerucic acid amide, N-laurylerucic acid amide, ethylenebisstearic acid amide, ethylenebisoleic acid amide, hexamethylenebisoleic acid amide, N,N′-dioleyladipic acid amide, and N,N′-dioleylsebacic acid amide.

The polypropylene composition of the present invention contains a metal silicate salt at 0.01 to 0.8 part by weight, preferably 0.1 to 0.75 part by weight, particularly preferably 0.2 to 0.6 part by weight based on 100 parts by weight of polypropylene.

When the metal silicate salt is 0.01 part by weight or more, there is a tendency that a modulus and a loading deflection temperature are elevated, thereby, mechanical property is excellent, that a GO embrittlement life is improved, and stability to thermal oxidation is stabilized such that repetition extrusion MFR is stabilized, and that NOₓ coloration is reduced, being preferable. When the metal silicate salt is 0.8 part by weight or less, there is a tendency that a GO embrittlement life is improved, being preferable.

As used herein, the metal silicate salt refers to a salt of at least one kind metal selected from the group consisting of an alkali metal such as sodium and potassium, a metal belonging to II Group elements such as calcium and magnesium, a metal belonging to III Group elements such as aluminum, iron, and manganese, with silicic acid. Among them, magnesium silicate, aluminum silicate, or mica which is a silicate salt of aluminum, potassium, magnesium, sodium, and iron is preferable due to easy availability. Particularly, magnesium silicate is preferable due to a tendency that low temperature impact property, moldability and coating property are improved.

Examples of aluminum silicate include natural aluminum silicate such as kaolin, agalmatolite, sericite, bentonite and fired clay, and synthetic aluminum silicate such as zeolite, Zeolex, and Silteg.

Examples of magnesium silicate include talc.

The metal silicate salt has an average particle diameter of usually around 0.5 to 30 μm, preferably 1 to 20 μm. When the average particle diameter is 0.5 μm to 30 μm, there is a tendency that dispersibility in polypropylene is better, and impact resistance of the resulting polypropylene is improved, being preferable. Herein, an average particle diameter of the metal silicate salt is a value measured with a sedimentation type automatic particle size distribution measuring instrument.

A water content of the metal silicate salt is usually around 0.1 to 1% by weight, preferably around 0.1 to 0.3% by weight. When the water content is 0.1% by weight or more, availability and storage are easy, being preferable. When the water content is 1% by weight or less, there is a tendency that trouble such as expansion at polypropylene processing is reduced, being preferable. Herein, the water content of the metal silicate salt is a value measured with a Karl Fischer's method.

Polypropylene used in the present invention is a polyolefin which contains a structural unit derived from propylene as a main component and may further contain a structural unit derived from ethylene, a structural unit derived from an α-olefin other than propylene such as 1-butene, 1-hexene, 3-methyl-1-pentene, and 4-methyl-1-pentene, a structural unit derived from a diene compound such as butadiene, ethylidenenorbornene, and dicyclopentadiene, a structural unit derived from (meth)acrylic acids such as (meth)acrylic acid, methyl(meth)acrylate, ethyl(meth)acrylate, and ethylhexyl(meth)acrylate, a structural unit derived from a vinyl compound such as styrene, vinyl chloride, vinyl acetate, and vinyl versatate, and acid anhydride such as maleic anhydride, and succinic anhydride.

Additionally, a polyolefin other than propylene such as polyethylene, polystyrene, and a synthetic rubber may be incorporated into the composition of the present invention. In order that mechanical property such as a bending modulus and a thermal deformation temperature, stability to thermal oxidation, and a hue of the resulting present composition are excellent, a content of other polyolefin is usually 10 parts by weight or less, preferably 1 part by weight or less, particularly preferably 0.1 part by weight or less based on 100 parts by weight of polypropylene.

Other additives may be further incorporated into the composition of the present invention in such a range that performance of the polypropylene composition is not influenced.

Specifically, examples include a light stabilizer such as 2-hydroxy-4-n-octoxybenzophenone, 2-(2-hydroxy-5-methyl phenyl)benzotriazole,
2-(3-t-butyl-2-hydroxy-5-methylphenyl)-5-chlorobenzotriazol e, 2,4-di-t-butylphenyl 3,5-di-t-butyl-4-hydroxybenzoate, bis(2,2,6,6-tetramethyl-4-piperidyl) sebacate, dimethyl succinate.
1-(2-hydroxyethyl)-4-hydroxy-2,2,6,6-tetramethylpiperidine polycondensate, and poly[{6-(1,1,3,3-tetramethyl butyl)amino-1,3,5-triazin-2,4-diyl}{(2,2,6,6-tetramethyl-4-piperidyl)imino}hexamethylene{(2,2,6,6-tetramethyl-4-piperi dyl) imino}],

a lubricant such as paraffin, low molecular weight polyethylene wax (molecular weight 10000 or less), low molecular weight polypropylene wax (molecular weight 10000 or less), stearic acid, butyl stearate, hydrogenated castor oil, and stearyl alcohol,

a cationic antistatic agent such as a primary amine salt, a tertiary amine salt, a quaternary amine salt and a pyridine derivative,

an anionic antistatic agent such as sulfated oil, soap, sulfated ester oil, sulfated amide oil, sulfated ester salts of olefin, aliphatic alcohol sulfuric acid ester salts, alkylsulfate ester salts, fatty acid ethylsulfonate salt, alkyl naphthalenesulfonate salt, alkyl benzenesulfonate salt, succinic acid ester sulfonate salt and phosphoric acid ester salt,

a nonionic antistatic agent such as partial fatty acid ester of polyhydric alcohol, ethylene oxide adduct of fatty alcohol, ethylene oxide adduct of fatty acid, ethylene oxide adduct of aliphatic amine or fatty acid amide, ethylene oxide adduct of alkylphenol, ethylene oxide adduct of partial fatty acid ester of polyhydric alcohol, and polyethylene glycol,

an amphoteric antistatic agent such as carboxylic acid derivative and imidazoline derivative,

an anti-fogging agent such as stearic acid monoglyceride, oleic acid monoglyceride, polyglycerin oleic acid ester, sorbitan monolaurate, and sorbitan monostearate,

a pigment such as carbon black, titanium oxide, phthalocyanine pigment, quinacridone pigment, isoindolinone pigment, perylene or perinine pigment, quinophthalone pigment, diketopyrrolopyrrole pigment, dioxazine pigment, disazo condensed pigment, and benzimidazolone pigment,

a flame-retardant such as decabromobiphenyl, antimony trioxide, phosphorus-based flame-retardant and aluminum hydroxide,

a nucleating agent such as sodium benzoate, sodium 2, 2′-methylene bis(4,6-di-t-butylphenyl) phosphate, and bis(p-methylbenzylidene) sorbitol.

The composition of the present invention is, for example, a mixture of the neutralizing agent, the phenol-based antioxidant (1), the sulfur-based antioxidant (2), the phosphorus-based antioxidant selected from the group consisting of the formulas (3) and (4), the metal silicate salt and polypropylene and, specifically, can be obtained by dry blending with a batch-type mixing machine such as a Henschel mixer, and a supermixer.

Alternatively, a different example of the process for producing the present composition includes a process of granulating the neutralizing agent, the phenol-based antioxidant (1), the sulfur-based antioxidant (2), the phosphorus-based antioxidant selected from the group consisting of formulas (3) and (4), and the metal silicate salt, for example, by a dry extrusion granulating method, or stirring granulation, separately melt-extruding polypropylene at 190° C. to 300° C. using a monoaxial or biaxial extruder, and placing the granules obtained thereupon through a side feeder to granulate into pellets.

The polypropylene composition of the present invention may be further injection-molded, or extrusion-molded through a T die while heating at 190° C. to 330° C., preferably 200° C. to 300° C., particularly preferably 210° C. to 280° C.

According to the present invention, it becomes possible to provide a polypropylene composition which is excellent in all of mechanical property, stability to thermal oxidation, and coloration resistance.

### EXAMPLES

The present invention will be explained in more detail below by way of Examples. Part and % denote a weight basis unless otherwise is indicated.

As Examples and Comparative Examples, those shown in Table 1 were used.

TABLE 1

| | |
|---|---|
| Polypropylene | Propylene/ethylene block copolymer (manufactured by Sumitomo |
| | Chemical; MFR = 30 g/10 min) |
| Neutralizing | N-1: Calcium stearate (manufactured by KYODO CHEMICAL CO., LTD.: |
| agent | calcium stearate) |
| | N-2: Hydrotalcite (manufactured by Kyowa Chemical Industry Co., Ltd: |
| | DHT-4A) |
| Phenol-based | (1-1): 3,9-Bis[2-{3-(3-t-butyl-4-hydroxy-5-methylphenyl) |
| antioxidant(1) | propionyloxy}-1,1-dimethylethyl]-2,4,8,10-tetraoxaspiro |
| | [5.5] undecane(manufactured by Sumitomo Chemical: SUMILIZER GA-80) |
| | (1-2): Tetrakis[3-(3,5-di-t-butyl-4-hydroxyphenyl) |
| | propionyloxymethyl]methane(manufactured by Ciba Specialty Chemicals: |
| | IRGANOX 1010) |
| Sulfur-based | (2-1): Dimyristyl 3,3′-thiodipropionate(manufactured by |
| antioxidant(2) | Sumitomo Chemical: SUMILIZER TPM) |
| | (2-2): Tetrakis(3-laurylthiopropionyloxymethyl)methane(manufactured by |
| | Sumitomo Chemical: SUMILIZER TP-D) |
| Phosphorus-based | (3-1): Tris(2,4-di-t-butylphenyl) phosphite(manufactured by |
| antioxidant(3) or | Ciba Specialty Chemicals: IRGAFOS 168) |
| (4) | (4-1): Bis(2,4-di-t-butylphenyl)pentaerythritol diphosphite |
| | (manufactured by ADEKA CORPORATION: ADEKASTAB PEP24G) |
| Metal silicate salt | Talc(manufactured by HAYASHI KASEI Co., Ltd.: |
| | MICRON WHITE 5000s) |

### Example 1

Into a Henschel mixer were placed 100 parts by weight of polypropylene, 0.05 part by weight of a neutralizing agent (N-1), 0.05 part by weight of a phenol-based antioxidant (1-1), 0.05 part by weight of a sulfur-based antioxidant (2-2), 0.05 part by weight of phosphorus-based antioxidant (4-1) and 0.05 part by weight of a metal silicate salt, all of which are described in Table 1, they were mixed at 1,000 rpm for 30 seconds, and then melt-extruded using a 30 mmφbiaxial extruder to obtain a pellet-like granulated polypropylene composition.

Subsequently, the resulting composition was injection-molded, and the resulting injection-molded specimen was assessed as follow. Results are summarized in Table 3.

### (Thermal Deformation Temperature)

A thermal deformation temperature was measured according to JIS K 7202 (1983) B Method. As this thermal deformation temperature is higher, it is meant that stability to thermal oxidation is more excellent.

### (Bending Modulus)

A bending modulus was measured according to JIS K 7171 (1994). When a bending modulus is higher, it is meant that mechanical property is more excellent.

(Measurement of Embrittlement Life with Gear Oven)

The injection-molded specimen (40 mm×40 mm×1 mm) was placed into a gear oven at 150° C., and an embrittled area on a surface was measured. Days until an embrittled area reached 30% was adopted as an embrittlement life. As the number of days is larger, it is meant that stability to thermal oxidation is more excellent.

### (Hue)

The injection-molded specimen (40 mm×40 mm×1 mm) was measured for a yellowness index (YI) using a color difference meter (SPECTROPHOTOMETER CM-3500d, MINOLTA). As the number of YI is smaller, it is meant that the composition is whiter and more excellent in a hue.

### (NOₓ Exposure Test)

### (Preparation)

The injection-molded specimen (40 mm×40 mm×1 mm) was hanged in a nitrogen oxide gas testing machine of a nitrogen oxide gas staining fastness tester, Model GF-5, manufactured by SUGA TEST INSTRUMENTS CO., LTD.

### (Preparation of NOₓ Gas)

A NOₓ gas was generated according to JIS L 0855 (1998), and the NOₓ gas was collected in a gas burette.

### (Exposure Test)

Ten mL of the NOₓ gas collected in a gas burette was sampled with a gas syringe, and injected into Model GF-5. After exposure at room temperature for 7 days while a propeller was rotated, a lid was released, a test piece was taken out, and YI was measured with a color difference meter.

### (Processing Stability)

The pellet (present composition) obtained by melt-kneading with a biaxial extruder was extruded with a 30 mmφ monoaxial extruder, and the extruded pellet was extruded again with the extruder. The pellet after five times repetition extrusion with the monoaxial extruder was measured for MFR.

MFR was automatically measured according to JIS K 7210 (1976) Test Condition, Condition 14 in Table 1. As MFR is smaller, it is meant that processing stability is more excellent.

### Examples 1 to 5, Comparative Examples 1 and 2

As described in Table 2, by changing a content of the metal silicate salt in a range of 0 to 1 part based on 100 parts of polypropylene, compositions were obtained as in Example 1.

Assessment was performed as in Example 1, and results are shown in Table 3 together with those of Example 1.

TABLE 2

| | | Phenol-based | Sulfur-based | Phosphorus-based | Neutralizing | Metal silicate |
|---|---|---|---|---|---|---|
| | Polypropylene | antioxidant | antioxidant | antioxidant | agent | salt |
| Example 1 | 100 parts | (1-1) | (2-2) | (4-1) | (N-1) | 0.05 part |
| | | 0.05 part | 0.05 part | 0.05 part | 0.05 part | |
| Example 2 | 100 parts | (1-1) | (2-2) | (4-1) | (N-1) | 0.1 part |
| | | 0.05 part | 0.05 part | 0.05 part | 0.05 part | |
| Example 3 | 100 parts | (1-1) | (2-2) | (4-1) | (N-1) | 0.25 part |
| | | 0.05 part | 0.05 part | 0.05 part | 0.05 part | |
| Example 4 | 100 parts | (1-1) | (2-2) | (4-1) | (N-1) | 0.5 part |
| | | 0.05 part | 0.05 part | 0.05 part | 0.05 part | |
| Example 5 | 100 parts | (1-1) | (2-2) | (4-1) | (N-1) | 0.75 part |
| | | 0.05 part | 0.05 part | 0.05 part | 0.05 part | |
| Comparative | 100 parts | (1-1) | (2-2) | (4-1) | (N-1) | 0.00 part |
| Example 1 | | 0.05 part | 0.05 part | 0.05 part | 0.05 part | |
| Comparative | 100 parts | (1-1) | (2-2) | (4-1) | (N-1) | 1.00 part |
| Example 2 | | 0.05 part | 0.05 part | 0.05 part | 0.05 part | |

TABLE 3

| | Bending | Thermal | | Repetition | | NOx |
|---|---|---|---|---|---|---|
| | modulus | deformation | GO embrittlement | extrusion | Initial hue | coloration |
| | (Mpa) | temperature(° C.) | life (day) | MFR (g/10 min) | YI (−) | YI (−) |
| Example 1 | 780 | 89 | 29 | 49 | −2.7 | 6.6 |
| Example 2 | 803 | 90 | 27 | 49 | −2.7 | 6.3 |
| Example 3 | 831 | 90 | 33 | 42 | −2.6 | 4.7 |
| Example 4 | 817 | 95 | 27 | 42 | −2.6 | 4.7 |
| Example 5 | 868 | 98 | 25 | 41 | −2.7 | 4.5 |
| Comparative | 635 | 75 | 22 | 50 | −2.3 | 6.8 |
| Example 1 | | | | | | |
| Comparative | 910 | 98 | 22 | 41 | −2.8 | 4.5 |
| Example 2 | | | | | | |

### Examples 6 to 9, Comparative Examples 3 to 5

As described in Table 4, by changing a content of the neutralizing agent in a range of 0 to 1 part based on 100 parts of polypropylene, compositions were obtained as in Example 1.

In addition to the aforementioned measurement items, roughening of a surface of an injection-molded specimen was assessed by a gloss value. Results are shown in Table 5. The gloss value was measured at an incident angle of 60° and a light receiving angle of 60° using a digital variable gloss meter manufactured by SUGA TEST INSTRUMENTS CO., LTD. As the number is larger, it is meant that roughening of a surface is smaller (smoother), and the surface is glossy.

TABLE 4

| | | Phenol-based | Sulfur-based | Phosphorus-based | Neutralizing | | Metal silicate |
|---|---|---|---|---|---|---|---|
| | Polypropylene | antioxidant | antioxidant | antioxidant | agent | | salt |
| Example 6 | 100 parts | (1-1) | (2-2) | (4-1) | (N-1) | | 0.5 part |
| | | 0.05 part | 0.05 part | 0.05 part | 0.001 part | | |
| Example 7 | 100 parts | (1-1) | (2-2) | (4-1) | (N-1) | | 0.5 part |
| | | 0.05 part | 0.05 part | 0.05 part | 0.05 part | | |
| Example 8 | 100 parts | (1-1) | (2-2) | (4-1) | (N-1) | | 0.5 part |
| | | 0.05 part | 0.05 part | 0.05 part | 0.1 part | | |
| Example 9 | 100 parts | (1-1) | (2-2) | (4-1) | (N-1) | | 0.5 part |
| | | 0.05 part | 0.05 part | 0.05 part | 0.3 part | | |
| Comparative | 100 parts | (1-1) | (2-2) | (4-1) | (N-1) | | 0.5 part |
| Example 3 | | 0.05 part | 0.05 part | 0.05 part | 0.000 part | | |
| Comparative | 100 parts | (1-1) | (2-2) | (4-1) | (N-1) | | 0.5 part |
| Example 4 | | 0.05 part | 0.05 part | 0.05 part | 1.0 part | | |
| Comparative | 100 parts | (1-1) | (2-2) | (4-1) | (N-1) | (N-2) | — |
| Example 5 | | 0.05 part | 0.05 part | 0.05 part | 0.05 part | 0.5 part | |

TABLE 5

| | | Thermal | | Repetition | | | |
|---|---|---|---|---|---|---|---|
| | Bending | deformation | GO | extrusion | | | |
| | modulus | temperature | embrittlement | MFR | Initial hue | NOx coloration | Gloss value |
| | (MPa) | (° C.) | life (day) | (g/10 min) | YI (−) | YI (−) | (%) |
| Example 6 | 922 | 102 | 34 | 44 | −2.7 | 1.7 | 76.0 |
| Example 7 | 929 | 98 | 32 | 42 | −2.9 | 3.3 | 76.2 |
| Example 8 | 911 | 101 | — | 43 | −2.9 | 3.9 | 77.4 |
| Example 9 | 894 | 99 | 26 | 47 | −2.9 | 4.2 | 77.1 |
| Comparative | 940 | 99 | 32 | 45 | −2.5 | 1.7 | 75.4 |
| Example 3 | | | | | | | |
| Comparative | 853 | 94 | 20 | 46 | −3.0 | 4.7 | 76.5 |
| Example 4 | | | | | | | |
| Comparative | 834 | 88 | 22 | 44 | −2.4 | 2.1 | 75.9 |
| Example 5 | | | | | | | |

### Examples 10 and 11, Comparative Examples 3 to 5

As described in Table 6, by changing a kind of the antioxidant based on 100 parts of polypropylene, compositions and injection-molded specimens were obtained as in Example 1.

Assessment was performed as in Example 1, and results are shown in Table 7.

TABLE 6

| | | Phenol-based | Sulfur-based | Phosphorus-based | Neutralizing | Metal silicate |
|---|---|---|---|---|---|---|
| | Polypropylene | antioxidant | antioxidant | antioxidant | agent | salt |
| Example 10 | 100 parts | (1-1) | (2-2) | (4-1) | (N-2) | 0.5 part |
| | | 0.05 part | 0.05 part | 0.05 part | 0.05 part | |
| Example 11 | 100 parts | (1-1) | (2-1) | (3-1) | (N-2) | 0.5 part |
| | | 0.05 part | 0.1 part | 0.1 part | 0.05 part | |
| Comparative | 100 parts | Not used | (2-2) | (4-1) | (N-1) | 0.5 part |
| Example 6 | | | 0.1 part | 0.1 part | 0.05 part | |
| Comparative | 100 parts | (1-2) | (2-2) | (4-1) | (N-1) | 0.5 part |
| Example 7 | | 0.05 part | 0.05 part | 0.05 part | 0.05 part | |
| Comparative | 100 parts | (1-1) | Not used | Not used | (N-1) | 0.5 part |
| Example 8 | | 0.05 part | | | 0.05 part | |

TABLE 7

| | Bending | Thermal | | Repetition | | NOx |
|---|---|---|---|---|---|---|
| | modulus | deformation | GO embrittlement | extrusion | Initial hue | coloration |
| | (MPa) | temperature(° C.) | life (day) | MFR (g/10 min) | YI (−) | YI (−) |
| Example 10 | 951 | 98 | 34 | 30 | −1.5 | 2.66 |
| Example 11 | 930 | 101 | 30 | 32 | −1.2 | 1.85 |
| Comparative | 906 | 96 | 8 | 40 | −2.2 | 4.94 |
| Example 6 | | | | | | |
| Comparative | 892 | 99 | 22 | 34 | −2.1 | 6.49 |
| Example 7 | | | | | | |
| Comparative | 917 | 97 | 7 | 53 | −1.3 | 6.37 |
| Example 8 | | | | | | |

From Tables 3, 5 and 7, it is seen that the polypropylene composition of the present invention is excellent in any performance of mechanical property, stability to thermal oxidation, and coloration resistance.

What is claimed is:

1. A polypropylene composition comprising 0.001 to 0.05 part by weight of at least one kind neutralizing agent selected from the group consisting of hydrotalcites, metal hydroxide and a carboxylic acid metal salt, 0.01 to 0.5 part by weight of a phenol-based antioxidant represented by the formula (1), 0.01 to 0.5 part by weight of a sulfur-based antioxidant represented by the formula (2), 0.01 to 0.5 part by weight of at least one kind phosphorus-based antioxidant selected from the group consisting of a compound represented by the formula (3) and a compound represented by the formula (4), 0.01 to 0.8 part by weight of a metal silicate salt, and 100 parts by weight of polypropylene, provided that, when a bisphenol A type glycidyl ether-based epoxide compound represented by the formula (5) and/or carboxylic acid amide having a carbon number of 8 to 50 are (is) contained in the composition, a content of the bisphenol A type glycidyl ether-based epoxide compound represented by the formula (5) is 0.001 part by weight or less, and a content of the carboxylic acid amide having a carbon number of 8 to 50 is 0.001 part by weight or less. 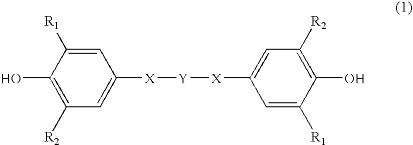
[In the formula (1), R₁s each represent independently a linear alkyl group having a carbon number of 1 to 8, or a branched alkyl group having a carbon number of 3 to 8, R₂s represent a methyl group, X represents a —C₂H₄COO— group, and Y represents a divalent alcohol residue having a carbon number of 1 to 18, wherein a methylene group contained in the alcohol residue may be substituted with a cycloalkylene group or a hatero atom, and a methylene group contained in the cycloalkylene group may be substituted with a hetero atom]
(R₃-A-S—C₂H₄CO₂)ₘ-Z (2)
[In the formula (2), R₃ represents an alkyl group having a carbon number of 12 to 18, A represents a single bond or a —C₂H₄CO₂— group, m represents an integer of 1 to 4, and Z represents a m-valent alcohol residue having a carbon number of 5 to 18] 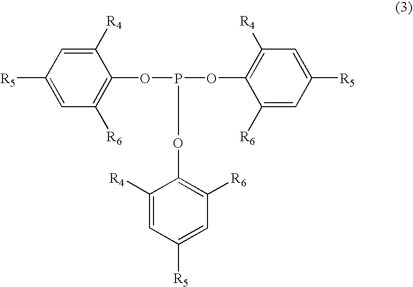
[In the formula (3), R₄s, R₅s and R₆s each represent independently a hydrogen atom, a linear alkyl group having a carbon number of 1 to 9, or a branched alkyl group having a carbon number of 3 to 9] 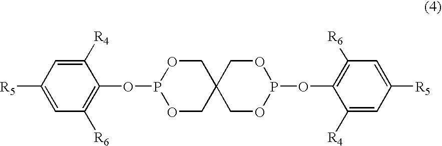
[In the formula (4), R₄S, R₅s and R₆s are as defined above] 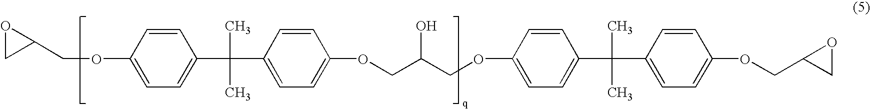
[In the formula (5), q represents a number of 0 or more]

2. The composition according to claim 1, wherein the composition does not substantially contain the bisphenol A type glycidyl ether-based epoxide compound represented by the formula (5) and the carboxylic acid amide having a carbon number of 8 to 50.

3. The composition according to claim 1, wherein the neutralizing agent is a carboxylic acid metal salt having a carbon number of 8 to 22.

4. The composition according to claim 1, wherein the neutralizing agent is hydrotalcites.

5. A method of stabilizing a polypropylene composition, comprising melt-kneading a composition comprising 0.001 to 0.5 part by weight of at least one kind neutralizing agent selected from the group consisting of hydrotalcites, metal hydroxide and a carboxylic acid metal salt, 0.01 to 0.5 part by weight of a phenol-based antioxidant represented by the formula (1), 0.01 to 0.5 part by weight of a sulfur-based antioxidant represented by the formula (2), 0.01 to 0.5 part by weight of at least one kind phosphorus-based antioxidant selected from the group consisting of a compound represented by the formula (3) and a compound represented by the formula (4), 0.01 to 0.8 part by weight of a metal silicate salt, and 100 parts by weight of polypropylene, provided that, when a bisphenol A type glycidyl ether-based epoxy compound represented by the formula (5) and/or carboxylic acid amide having a carbon number of 8 to 50 are (is) contained in the composition, a content of the bisphenol A type glycidyl ether-based epoxy compound represented by the formula (5) is 0.001 part by weight or less, and a content of the carboxylic acid amide having a carbon number of 8 to 50 is 0.001 part by weight or less.

6. The composition according to claim 5, wherein the composition does not substantially contain the bisphenol A type glycidyl ether-based epoxy compound represented by the formula (5) and the carboxylic acid amide having a carbon number of 8 to 50.
